(19) United States
(12) Patent Application Publication
(10) Pub. No.: US 2017/0305259 A1
(43) Pub. Date: Oct. 26, 2017

(54) Hybrid Vehicle And Vehicle Hybridization Method

(71) Applicant: LOHR ELECTROMECANIQUE, Hangenbieten (FR)

(72) Inventors: Pierre Dumas, Strasbourg (FR); Laurent Verdier, Eschau (FR)

(73) Assignee: LOHR ELECTROMECANIQUE, Hangenbieten (FR)

(21) Appl. No.: 15/517,889

(22) PCT Filed: Oct. 16, 2015
(86) PCT No.: PCT/FR2015/052787

§ 371 Date: Apr. 7, 2017

(30) Foreign Application Priority Data
Oct. 17, 2014 (FR) 1459987

(51) Int. Cl. B60K 6/485; B60W 20/14; B60K 6/40; B60W 20/16; B60K 6/26

(52) U.S. Cl. CPC B60K 6/485; B60K 6/40; B60W 20/16; B60W 20/14; B60K 2006/266; B60L 2200/18

(57) ABSTRACT

A vehicle that includes: a towing axle connected to a heat engine; a directional axle; and a complementary axle that is neither directional nor motor-driven. When the vehicle is hybridized according to the method of the invention, the wheels of the complementary axle are removed and replaced by in-wheel motors, each connected with an inverter specifically dedicated for supplying electrical power thereto from an electrical power battery. A control housing is also provided, that has built-in acceleration control devices connected to the accelerator pedal, and built-in deceleration control devices connected to the brake pedal, so as to control and monitor all the mechanisms needed for the driver to transparently accelerate and decelerate the vehicle.

### FIELD OF THE INVENTION

The present invention relates to a method of hybridizing a vehicle, for example an articulated bus or a guided public transport vehicle, comprising a heat engine driven towing axle, a directional axle and a complementary axle integrating an electric drive with power supplied by an electrical power battery. The invention also concerns a hybrid vehicle thus obtained.

More particularly, the invention concerns a hybridized vehicle wherein the electric drive and the electrical power batteries occupy a minimum amount of space within the vehicle and can be integrated into an existing vehicle.

### BACKGROUND OF THE INVENTION

For reasons of energy savings and reduction of emissions of CO2 and pollutant gases, it is advantageous to provide hybrid vehicles designed to use both a conventional heat engine and an electric drive with power provided by an electrical power battery, which is recharged in particular during the deceleration phases of the vehicle.

However, the addition of an electric drive and an electrical power battery to a public transport bus requires significant structural changes.

There is therefore a need for a hybrid vehicle wherein the electric drive and the electrical power battery occupy a minimum amount of space inside the vehicle.

Advantageously, the technical solution considered should be easily adaptable and at low cost to a conventional heat engine vehicle.

### SUMMARY OF THE INVENTION

The object of the present invention, therefore, is to remedy the disadvantages of the prior art by proposing a new method of hybridizing a vehicle.

The objects assigned to the invention are achieved through a method of hybridizing a vehicle comprising:
a hydraulic or pneumatic braking system actuated by a brake pedal through braking control devices;
a towing axle connected to a heat engine through a gearbox integrating a speed reducer, the heat engine being controlled in acceleration by an accelerator pedal and the speed reducer being controlled in deceleration by the brake pedal;
a directional axle actuated by a steering wheel; and
a complementary axle;

characterized in that it comprises:
installing an electrical power battery on or in the vehicle;
removing the wheels of the complementary axle and replacing them by in-wheel motors, each in-wheel motor being associated with an inverter, each inverter being connected and dedicated to one of the in-wheel motors in order to supply electrical energy thereto from the electrical power battery;
installing a control housing that has built in acceleration control devices connected to the accelerator pedal and built in deceleration control devices connected to the brake pedal;
connecting said control housing:
   to the brake pedal in order to receive a deceleration instruction therefrom;
   to the accelerator pedal to receive an acceleration instruction therefrom;
   to the electrical power battery in order to receive information concerning the level of charge thereof;
   to the inverters in order to transmit an acceleration or deceleration torque instruction to the in-wheel motors;
   to the speed reducer in order to transmit a deceleration instruction thereto;
   to the heat engine in order to transmit an acceleration torque instruction thereto; and
   to the braking system in order to receive a stop-traction instruction during braking.

According to one implementation example of the invention, the method further comprises installing an air or water heat exchanger to cool the inverters, the in-wheel motors and the electrical power battery.

According to another implementation example of the invention wherein the vehicle comprises an electrical system supplied with electricity by an alternator of the heat engine and a current converter connected to the electrical power battery, the method further comprises the following steps:
connecting the current converter to the electrical system in order to furnish electricity to the vehicle in the event that the heat engine stops; and
connecting the control housing to the electrical system.

According to one implementation example of the invention, the method further comprises arranging the electrical power battery on the roof of the vehicle or housing it within a cabinet on board the vehicle.

According to an additional implementation example of the invention, the method further comprises integrating traction batteries or quick-recharge super-capacity type batteries into the electrical power battery.

According to one implementation example of the invention, the method further comprises furnishing electrical devices to the inverters, said electrical devices being controlled by the control housing and designed to make the in-wheel motors operate according to a traction mode and a braking mode;
in traction mode, the in-wheel motors participating in the propulsion of the vehicle;
in braking mode, the in-wheel motors recharging the electrical power battery and slowing the vehicle by an electromagnetic braking effect.

According to another implementation example of the invention, if the control housing receives a deceleration instruction, said housing controls:
the inverters in order to cause the in-wheel motors to function in braking mode and to slow the vehicle;
the speed reducer in order to slow the vehicle;

the overall slowing achieved by the in-wheel motors and the speed reducer being in accordance with the deceleration instruction received by the control housing.

According to an additional implementation example of the invention, the control housing actuates the speed reducer when the electromagnetic braking of the in-wheel motors is insufficient to fulfill the deceleration instruction received by the control housing or when the electrical power battery is at full charge.

According to one implementation example of the invention, if the control housing receives an acceleration instruction, said housing controls:
the inverters in order to cause the in-wheel motors to function in traction mode;
the heat engine in order to transmit an acceleration torque instruction thereto;

the overall acceleration achieved by the in-wheel motors and the heat engine is in accordance with the acceleration instruction received by the control housing.

According to another implementation example of the invention, the method further comprises providing prioritizing devices to the control housing, said prioritizing devices being designed to choose whether the torque instruction transmitted to the heat engine should be greater than the one transmitted to the in-wheel motors, and vice versa.

According to an additional implementation example of the invention, the acceleration torque instruction transmitted by the control housing to the heat engine depends on the charge of the electrical power battery, on the acceleration torque instruction transmitted to the in-wheel motors and on the effective acceleration torque delivered by said in-wheel motors, and on the operating strategy in effect.

According to one implementation example of the invention, when the electrical power battery is discharged, the in-wheel motors are placed in braking mode and only the heat engine propels the vehicle for the time required to at least partially recharge the electrical power battery.

According to another implementation example of the invention, the method further comprises adding a so-called “stop-start” function to the vehicle, designed to make said vehicle start using only the in-wheel motors, then after reaching a certain speed, starting the heat engine by means of the gearbox.

According to an additional implementation example of the invention, when the electrical power battery is not sufficiently charged to start the vehicle by means of the in-wheel motors, said vehicle is started by means of the heat engine, and the in-wheel motors are then placed in braking mode to recharge the electrical power battery.

The objects assigned to the invention are also achieved by means of a vehicle hybridized by the vehicle hybridization method as described above, wherein said vehicle is an articulated public transport bus, a multi-articulated vehicle or a guided public transport vehicle.

The advantages of the present invention are particularly numerous.

Because the electric drive is integrated into the wheels in the form of an axle integrating in-wheel motors, said drive does not occupy any additional space compared to the conventional axle thus replaced.

Similarly, the electrical power battery can be arranged on the roof of the vehicle and thus does not occupy any space provided for the passengers.

In addition to the substantial fuel savings achieved conventionally by the addition to the vehicle of an electric drive, the invention also makes it possible to significantly increase the working life of the heat engine thereof. Indeed, the heat engine is less utilized than in a conventional vehicle, and when significant torque is necessary, the heat engine can be relieved in its efforts by additional power furnished by the electric drive. It is estimated that the hybridization method of the invention allows the working life of the heat engine of a vehicle to be increased by 50%.

By adding an electric drive to a complementary axle, i.e. one that is neither directional nor motor-driven, the vehicle thus hybridized has a better grip on the road and better road holding, which in particular makes it possible to avoid the phenomenon of jackknifing when the front part of an articulated bus begins to skid on the road.

Comprising a control housing integrating particularly the vehicle's acceleration control devices and deceleration control devices, the invention advantageously makes it possible to intelligently control the vehicle's motorizations and its deceleration devices, without the intervention of the driver and in a way that is totally transparent to him. In particular, this makes it possible to optimize the consumption of electricity and fuel, and to control for example the in-wheel motors individually in order, if needed, to be able to transmit a different acceleration or deceleration torque instruction to each of the in-wheel motors, or to reduce the torque control transmitted to both wheels.

The hybridization of a conventional vehicle amounts globally to install an electrical power battery on or on board the vehicle and to replace the wheels of a complementary axle with in-wheel motors. The invention can easily be adapted and at lower cost to any existing vehicle having a complementary axle that is neither directional nor motor driven, and comprising converters to control the in-wheel motors.

The invention can therefore be adapted to buses, but also to guided vehicles of the tramway type or railway vehicles. Thus, as a result of its hybridization, a guided vehicle can pass through particular areas completely autonomously, with the heat engine turned off.

### BRIEF DESCRIPTION OF THE DRAWINGS

Other characteristics and advantages of the present invention will more clearly appear from the following description, provided with reference to the appended drawings, provided by way of non-limiting examples, wherein:

FIG. 1 is a profile view of an articulated public transport bus hybridized according to the method of the invention, wherein the means of the invention are represented schematically;

FIG. 2 is a top view of an articulated public transport bus hybridized according to the method of the invention, wherein the means of the invention are represented schematically; and

FIG. 3 is a partial schematic view of the electrical system of a hybridized vehicle according to the method of the invention.

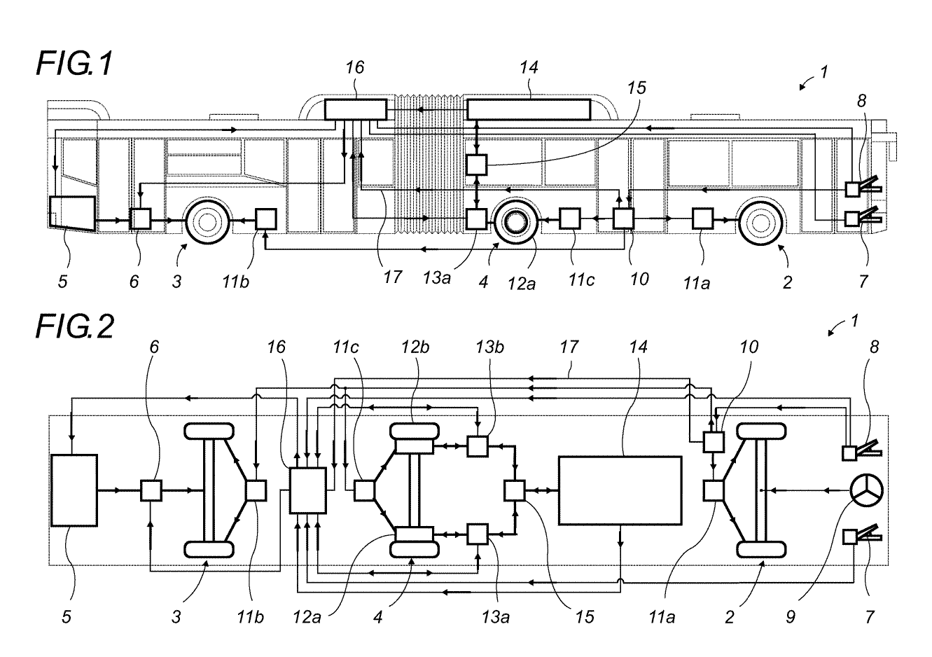

### DETAILED DESCRIPTION OF THE INVENTION

The structurally and functionally identical elements shown in several different figures are assigned the same numerical or alphanumerical reference.

In the figures, the control lines are represented by thin lines while the mechanical connections and electrical energy transfer lines are represented by thicker lines.

In the following description, provided solely by way of example, we are concerned with an articulated public transport bus. It is evident to a person skilled in the art that the invention can be adapted to any type of vehicle comprising at least three axles one of which is non-motorized and non-directional, which can be replaced by an axle comprising in-wheel motors.

A vehicle (1) such as an articulated public transport bus or a guided public transport vehicle normally comprises a directional axle (2) generally situated at the front, a motor-driven towing axle (3) generally situated to the rear, as well as a complementary axle (4), that is neither directional nor motor-driven and generally situated in a central position.

In such a vehicle, the towing axle (3) is mechanically connected to a heat engine (5) through a transmission and a gearbox (6) that normally has an integrated speed reducer.

The heat engine (5) is controlled in acceleration by an accelerator pedal (7) by means of known acceleration control devices, while the speed reducer is controlled in deceleration by a brake pedal (8) through known deceleration control devices.

The directional axle (2) is conventionally actuated by a steering wheel (9).

The complementary axle (4) is an axle serving particularly as supplemental support for the chassis of the vehicle (1). It is mechanically independent of the other axles (2, 3) and is not motor driven.

A vehicle (1) such as an articulated bus or a guided public transport vehicle also comprises a hydraulic or pneumatic braking system (10) actuated by the brake pedal (8) through braking control devices. Said braking system (10) controls the brakes (11a, 11b, 11c) in such a way that they are actuated hydraulically or pneumatically by mechanical brake actuators located on the vehicle wheels (1).

The braking system (10) is for example an electronic braking system (EBS), controlling the braking of all of the axles and integrating an antilock braking system (ABS), an electronic stability program (ESP) and an antiskid system.

Although not shown in the drawings for purposes of simplification, the wheels of the complementary axle (4) comprise brakes controlled by the hydraulic or pneumatic braking system (10) of the vehicle (1).

The brake pedal (8) has two successive displacements. The angle of insertion corresponding to the first displacement constitutes a deceleration instruction, while the angle of insertion corresponding to the second displacement constitutes a braking instruction. The purpose of the deceleration instruction is to slow the vehicle (1), while the purpose of the braking instruction is to stop it or slow it very forcefully and quickly in case of emergency.

In a vehicle (1), the deceleration instruction is normally transmitted to the speed reducer of the gearbox (6) by deceleration control devices, while the braking instruction is transmitted to the braking system (10) by braking control devices.

Conventionally, the angle of insertion of the accelerator pedal (7) constitutes an acceleration instruction that is transmitted to the heat engine (5) in order to transmit an acceleration torque instruction thereto.

An accelerator pedal (7) can be imagined with two successive displacements, the angle of insertion corresponding to the first displacement constituting a normal acceleration instruction, corresponding to a gentle and progressive acceleration, while the insertion angle corresponding to the second displacement constitutes a strong acceleration instruction, corresponding to very rapid and abrupt acceleration. In such a case, the purpose of the normal acceleration instruction is to accelerate the vehicle (1) gently, while the purpose of the strong acceleration instruction is to accelerate the vehicle (1) very forcefully and rapidly, particularly in the event of overtaking or in the case of emergency.

In the hybridized vehicle (1) according to the method of the invention, the complementary axle (4) is an electric driven towing axle integrating a pair of in-wheel motors (12a, 12b), each in-wheel motor (12a, 12b) being connected to a dedicated inverter (13a, 13b) in order to be supplied with electric energy by an electrical power battery (14).

A power distribution unit (15) is provided between the electrical power battery (14) and the inverters (13a, 13b). In particular, said unit enables the electrical power from the inverters (13a, 13b) to be cut off for the safety of operators having to provide maintenance to the inverters (13a, 13b) and the in-wheel motors (12a, 12b).

Optionally, and not shown in the figures, the electrical power battery (14) can also be connected to a brake chopper which in turn is connected to a brake resistor.

The electrical power battery (14) is preferably arranged on the roof of the vehicle (1) such as not to occupy space reserved for passengers. It can also be housed within a cabinet on board the vehicle (1). It can also be in various parts distributed in different places of the vehicle (1).

The electrical power battery (14) preferably comprises traction batteries or quick-recharge super-capacity batteries.

The in-wheel motors (12a, 12b) each comprise an electric motor incorporated into a wheel. They are particularly advantageous because they require limited space and do not need a transmission, which advantageously makes it possible to remove the complementary axle (3) of a vehicle (1) and to replace it with an axle comprising in-wheel motors (12a, 12b).

The inverters (13a, 13b) comprise electrical devices provided in order to make the in-wheel motors (12a, 12b) operate in a traction mode or in a braking mode.

In traction mode, the in-wheel motors (12a, 12b) are supplied with electric energy by the electrical power battery (14) and they function as motors in order to participate in the propulsion of the vehicle (1).

In braking mode, the in-wheel motors (12a, 12b) are driven in rotation by the inertia of movement of the vehicle (1) and function as electrical current generators. They then recharge the electrical power battery (14) and slow the vehicle (1) by means of an electromagnetic braking effect.

According to one operating strategy example, if the electrical power battery (14) is completely discharged, the in-wheel motors (12a, 12b) are placed in braking mode and only the heat engine (5) propels the vehicle (1) for the time required to at least partially recharge the electrical power battery (14).

The vehicle (1) of the invention comprises a control housing (16) which comprises all of the electronics and intelligence necessary particularly for the command and control of the heat engine (5), the speed reducer of the gearbox (6), the inverters (13a, 13b) and the electrical power battery (14).

The control housing (16) is connected to:
the brake pedal (8) in order to receive a deceleration instruction therefrom;
the accelerator pedal (7) in order to receive an acceleration instruction therefrom;
the electrical power battery (14) in order to receive information concerning the level of charge thereof;
the inverters (13a, 13b) in order to transmit an acceleration or deceleration torque instruction to the in-wheel motors (12a, 12b);
the speed reducer in order to transmit a deceleration instruction thereto; and
the heat engine (5) in order to transmit an acceleration torque instruction thereto.

The control housing (16) is connected to the different resources cited above such as to notably receive acceleration and deceleration instructions respectively from the accelerator pedal (7) and the brake pedal (8). It defines the instructions and adapts them in real time to an operating strategy.

Thus, the control housing (16) makes it possible to emulate everything totally transparently for the driver, that is, without the driver being aware of it because he operates the accelerator pedal (7) and the brake pedal (8) in a conventional way in order to accelerate or decelerate the vehicle (1).

When it receives an acceleration instruction, the control housing (16) controls the heat engine (5) in order to transmit an acceleration torque instruction thereto, as well as the inverters (13a, 13b) in order to make the in-wheels (12a, 12b) operate in traction mode.

The acceleration torque instruction transmitted to the in-wheel motors (12a, 12b) is compatible with the charged status of the electrical power battery (14), such that an acceleration torque instruction is not transmitted to the inverters (13a, 13b) if the charge status of the electrical powered battery (14) is insufficient.

According to one operating strategy example, the respective acceleration instructions transmitted to the inverters (13a, 13b) and to the heat engine (5) are intelligently determined by the control housing (16) such as to relieve the heat engine (5) thanks to the electric motors of the in-wheel motors (12a, 12b), while ensuring that a certain charge is preserved in the electrical power battery (14) in the that event the power of the heat engine (5) proves to be insufficient to respond to the acceleration instruction received from the accelerator pedal.

Thus, the control housing (16) comprises prioritizing devices in order to choose whether the torque instruction transmitted to the heat engine (5) should be greater than the instruction transmitted to the in-wheel motors (12a, 12b), and vice versa.

In general, the overall acceleration obtained by the in-wheel motors (12a, 12b) and the heat engine (5) is in accordance with the acceleration instruction received by the control housing (16).

In some cases, the acceleration instruction transmitted to the inverters (13a, 13b) or to the heat engine (5) may be zero, for example in the event of failure of the heat engine (5) or if the electrical power battery (14) is completely discharged.

When it receives a deceleration instruction, the control housing (16) controls the speed reducer and the inverters (13a, 13b) in order to cause the in-wheel motors to operate in braking mode, which makes it possible to slow the vehicle (1).

The deceleration torque instruction transmitted to the inverters (13a, 13b) is compatible with the charge status of the electrical power battery (14), so that such an instruction is not transmitted if the charge status of the electrical power battery (14) does not allow it to receive an additional amount of electrical energy from the in-wheel motors (12a, 12b) operating as current generators.

The respective deceleration instructions transmitted to the speed reducer and to the inverters (13a, 13b) are intelligently determined by the control housing (16) such as to favor as much as possible the operation of the in-wheel motors in braking mode, which enables the electrical power battery (14) to be recharged, while ensuring that the charge capacity thereof is not exceeded and actuating the speed reducer when the electromagnetic braking of the in-wheel motors (12a, 12b) is insufficient to satisfy the deceleration instruction received by the control housing (16).

In some cases, the deceleration instruction transmitted to the speed reducer or to the inverters (13a, 13b) may be zero, for example in a case wherein the electrical power battery (14) is at maximum charge.

The acceleration or deceleration torque instruction transmitted to each of the inverters (13a, 13b) also corresponds to a zero torque when at least one of the in-wheel motors (12a, 12b) transmits to the control housing (16) information relating to loss of grip of the in-wheel motor (12a, 12b) concerned. Said information is then transmitted by means of a link (17) between the braking system (10) and the control housing (16).

It will be noted that for obvious safety reasons the braking, utilized particularly in the case of an emergency, is not controlled by the control housing (16). Thus, in the event of failure of the control housing (16), braking always remains operational.

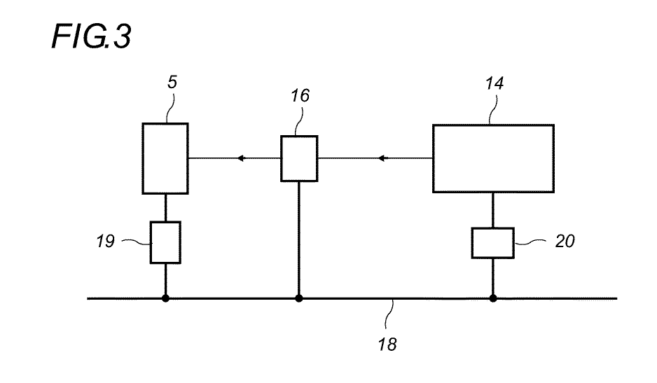

As shown in FIG. 3, the vehicle (1) of the invention comprises an electrical system (18), normally 24 Volts. Power is normally supplied to said electrical system (18) by an alternator (19) of the heat engine (5). However, in the case of a hybrid vehicle (1) according to the invention, the heat engine (5) can be turned off, making it necessary to supply power to the electrical system (18) of the vehicle (1) by means of the electrical power battery (14), for example by means of a current converter (20). It will be noted that the electrical system (18) normally supplies power to the different electrical resources of the vehicle (1), particularly lighting, heating and air conditioning, and in the case of the invention, the control housing (16).

The invention concerns a method of hybridizing a vehicle (1), for example an articulated or multi-articulated public transport bus, as described previously and comprising a non-motorized complementary axle.

Said method of hybridization consists of installing an electrical power battery (14) on the vehicle (1), or on board thereof, preferably in such a way as not to occupy space reserved for passengers.

The hybridization method also consists of removing the wheels of the complementary axle (4) and replacing them with in-wheel motors (12a, 12b) each connected to a dedicated inverter (13a, 13b) such as to be supplied with electric energy by the electrical power battery (14).

A control housing (16) that has built in acceleration control devices connected to the accelerator pedal (7) and built in deceleration control devices connected to the brake pedal (8) is also installed on board the vehicle (1).

Said control housing (16) is connected to the accelerator pedal (7) and to the brake pedal (8). Thus, the control housing (16) receives acceleration and deceleration instructions from the driver.

Also connected thereto is the electrical power battery (14), in order to receive information concerning the level of charge thereof.

The control housing (16) is also connected to the inverters (13a, 13b), to the heat engine (5) and to the speed reducer in order to transmit to each of them an acceleration or deceleration torque instruction which is a function of the acceleration and deceleration instructions received from the driver by means of the pedals (7, 8).

Thus, the control housing (16) emulates the normal resources of acceleration and deceleration control in order to control the in-wheel motors (12a, 12b), the heat engine (5) and the speed reducer based on information transmitted to the pedals (7, 8) by the driver, without the driver sensing a difference in the level of driving compared to driving a conventional vehicle.

According to a preferred embodiment of the invention, the hybridized vehicle (1) according to the invention method can advantageously comprise a so-called “stop-start” function. Thus, the hybridized vehicle (1) starts while using only the in-wheel motors (12a, 12b), then after reaching a certain speed, it starts the heat engine (5) by means of the gearbox (6), which in particular makes it possible to save fuel and to not utilize the starter of the vehicle (1).

In the event that the electrical power battery (14) is not sufficiently charged in order to start the vehicle (1) by means of the in-wheel motors (12a, 12b), the vehicle is started by means of the heat engine (5). The in-wheel motors (12a, 12b) are then placed in braking mode in order to recharge the electrical power battery (14) such that during the next startup, the heat engine (5) is not utilized.

It is evident that this description is not limited to the examples explicitly described, but that it also comprises other embodiments and/or implementations. Thus, one described technical characteristic can be replaced by an equivalent technical characteristic without going beyond the scope of the invention, and one described functional step of implementation of the method can be replaced by an equivalent step without departing from the scope of the invention.

1. A method of hybridizing a vehicle comprising:
a hydraulic or pneumatic braking system actuated by a brake pedal through braking control devices;
a towing axle connected to a heat engine through a gearbox integrating a speed reducer, the heat engine being controlled in acceleration by an accelerator pedal and the speed reducer being controlled in deceleration by the brake pedal;
a directional axle actuated by a steering wheel; and
a complementary axle;
characterized in that the method of hybridizing a vehicle comprises the steps of:
installing an electrical power battery on or in the vehicle;
removing wheels of the complementary axle and replacing them by in-wheel motors, each in-wheel motor being associated with an inverter, each inverter being connected and dedicated to one of the in-wheel motors in order to supply electrical energy thereto from the electrical power battery;
installing a control housing that has built in acceleration control devices connected to the accelerator pedal and built in deceleration control devices connected to the brake pedal;
connecting said control housing to:
the brake pedal in order to receive a deceleration instruction therefrom;
the accelerator pedal in order to receive an acceleration instruction therefrom;
the electrical power battery in order to receive information concerning a level of charge thereof;
the inverters in order to transmit an acceleration or deceleration torque instruction to the in-wheel motors;
the speed reducer in order to transmit a deceleration instruction thereto;
the heat engine in order to transmit an acceleration torque instruction thereto; and
the braking system in order to receive a stop-traction instruction during braking.

2. The method of hybridizing a vehicle according to claim 1, characterized in that the method of hybridizing a vehicle further comprises the step of installing an air or water heat exchanger to cool the inverters, the in-wheel motors and the electrical power battery.

3. The method of hybridizing a vehicle according to claim 1, said vehicle comprising an electrical system supplied with electricity by an alternator of the heat engine and a current converter connected to the electrical power battery, characterized in that the method further comprises the following steps:
connecting the current converter to the electrical system in order to furnish electricity to the vehicle in the event the heat engine stops; and
connecting the control housing to the electrical system.

4. The method of hybridizing a vehicle according to claim 1, characterized in that it the method of hybridizing a vehicle further comprises the step of arranging the electrical power battery on a roof of the vehicle or housing the electrical power battery in a cabinet on board the vehicle.

5. The method of hybridizing a vehicle according to claim 1, characterized in that the method of hybridizing a vehicle further comprises the step of integrating traction batteries or quick-recharge super-capacity type batteries into the electrical power battery.

6. The method of hybridizing a vehicle according to claim 1, characterized in that the method of hybridizing a vehicle further comprises the step of furnishing electrical devices to the inverters, said electrical devices being controlled by the control housing and designed to make the in-wheel motors operate according to a traction mode and a braking mode;
in traction mode, the in-wheel motors participating in the propulsion of the vehicle;
in braking mode, the in-wheel motors recharging the electrical power battery and slowing the vehicle by means of an electromagnetic braking effect.

7. The method of hybridizing a vehicle according to claim 1, characterized in that, in case of a deceleration instruction received by the control housing, said housing controls:
the inverters in order to cause the in-wheel motors to function in braking mode and to slow the vehicle;
the speed reducer to slow the vehicle;
the overall slowing achieved by the in-wheel motors and the speed reducer being in accordance with the deceleration instruction received by the control housing.

8. The method of hybridizing a vehicle according to claim 1, characterized in that the control housing actuates the speed reducer when the electromagnetic braking of the in-wheel motors is insufficient to satisfy the deceleration instruction received by the control housing or when the electrical power battery is fully charged.

9. The method of hybridizing a vehicle according to claim 1, characterized in that, in the case of an acceleration instruction received by the control housing, said housing controls:
the inverters in order to cause the in-wheel motors to function in traction mode;
the heat engine in order to transmit an acceleration torque instruction thereto;
an overall acceleration achieved by the in-wheel motors and the heat engine being in accordance with the acceleration instruction received by the control housing.

10. The method of hybridizing a vehicle according to claim 1, characterized in that the method of hybridizing a vehicle further comprises the step of providing prioritizing devices to the control housing, said prioritizing devices being designed to choose whether the torque instruction transmitted to the heat engine should be greater than the one transmitted to the in-wheel motors, and vice versa.

11. The method of hybridizing a vehicle according to claim 1, characterized in that the acceleration torque instruction transmitted by the control housing to the heat engine depends on a charge of the electrical power battery, on an acceleration torque instruction transmitted to the in-wheel motors and on an effective acceleration torque delivered by said in-wheel motors, and on an operating strategy in effect.

12. The method of hybridizing a vehicle according to claim 1, characterized in that, when the electrical power battery is discharged, the in-wheel motors are placed in braking mode and only the heat engine propels the vehicle for a time required to at least partially recharge the electrical power battery.

13. The method of hybridizing a vehicle according to claim 1, characterized in that the method of hybridizing a vehicle further comprises the step of adding a so-called “stop-start” function to the vehicle, designed to make said vehicle start using only the in-wheel motors, then after reaching a certain speed, starting the heat engine by means of the gearbox.

14. The method of hybridizing a vehicle according to claim 1, characterized in that when the electrical power battery is not sufficiently charged to start the vehicle by means of the in-wheel motors, the vehicle is started by means of the heat engine, and in that the in-wheel motors are then placed in braking mode in order to recharge the electrical power battery.

15. A vehicle hybridized by the hybridization method of a vehicle according to claim 1, characterized in that said vehicle is at least one of the following: an articulated public transport bus, a multi-articulated vehicle, or a guided public transport vehicle.
